(19) United States
(12) Patent Application Publication
(10) Pub. No.: US 2011/0023443 A1
(43) Pub. Date: Feb. 3, 2011

(54) MULTI-RAKE

(76) Inventor: LUKE HATFIELD, Saint John (CA)

Correspondence Address: James Ray & Associates, 2640 Pitcairn Road, Monroeville, PA, 15146, US

(21) Appl. No.: 12/818,417

(22) Filed: Jun. 18, 2010

Related U.S. Application Data
(60) Provisional application No. 61/230,356, filed on Jul. 31, 2009.

(51) Int. Cl. A01D 7/00; B65B 67/04; A01D 7/10

(52) U.S. Cl. 56/400.11

(57) ABSTRACT

The present invention is a lawn tool designed to provide convenience to the consumer. This tool features an area to attach a garbage bag, which allows for the easy transport of leaves, grass, and debris to the recycle bin or garbage. The device comes with a variety of outdoor attachment heads that include a lawn and garden rake, a broom, and a weed removal tool. This product saves users time and money by allowing them to do a variety of tasks with one easy to use tool.

### CROSS REFERENCE TO RELATED APPLICATION

This patent application is related to and claims priority from U.S. Provisional Patent Application Ser. No. 61/230,356 filed Jul. 31, 2009.

### FIELD OF THE INVENTION

This invention generally pertains to yard tools. More specifically, the present invention relates to an improved rake and refuse collection device.

### BACKGROUND OF THE INVENTION

The invention is particularly applicable to rakes and other yard tools and will be described in related to such tools. However, it will be appreciated by those skilled in the art that the invention has broader applications and may also be adapted for use in other debris collecting tools.

Doing lawn and garden work can be a time consuming task. Multiple tools are required for each job, which can be costly. Homeowners find themselves spending hours bagging leaves, raking the lawn, and sweeping the driveway. A fair amount of the time is spent switching equipment. A more versatile tool is needed to allow users to complete the job in less time.

Accordingly, it has been considered desirable to develop a new and improved rake which would overcome the foregoing difficulties and others while providing better and more advantageous overall results.

### SUMMARY OF THE INVENTION

The present invention is a lawn tool designed to provide convenience to the consumer. This tool features an area to attach a garbage bag, which allows for the easy transport of leaves, grass, and debris to the recycle bin or garbage. The device comes with a variety of outdoor attachment heads that include a lawn and garden rake, a broom, and a weed removal tool. This product saves users time and money by allowing them to do a variety of tasks with one easy to use tool. In several embodiments the lawn tool of the present invention is a single purpose tool without interchangeable attachments.

### OBJECTS OF THE INVENTION

It is, therefore, one of the primary objects of the present invention to provide a yard tool that serves multiple purposes.

Another object of the present invention is to provide a rake with a sealable debris bag or compartment.

Still another object of the present invention is to provide a rake with a pivoting arm for sealing a debris bag or compartment.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention; and together with the description serve to explain the principles and operation of the invention.

### BRIEF DESCRIPTION OF THE DRAWINGS

FIG. 1 is a schematic view of one preferred embodiment of the present invention.

FIG. 2 is a schematic view of another preferred embodiment of the present invention.

FIG. 3 is a close up view of a preferred embodiment of the present invention.

FIG. 4 is a close up view of a preferred embodiment of the present invention.

FIG. 5 is a perspective view of a preferred embodiment of the present invention being used by a user to rake leaves.

FIG. 6 is a perspective view of a preferred embodiment of the present invention being used by user to collect a pile of leaves.

FIG. 7 is a perspective view of a preferred embodiment of the present invention with the bag closed by a rake head.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

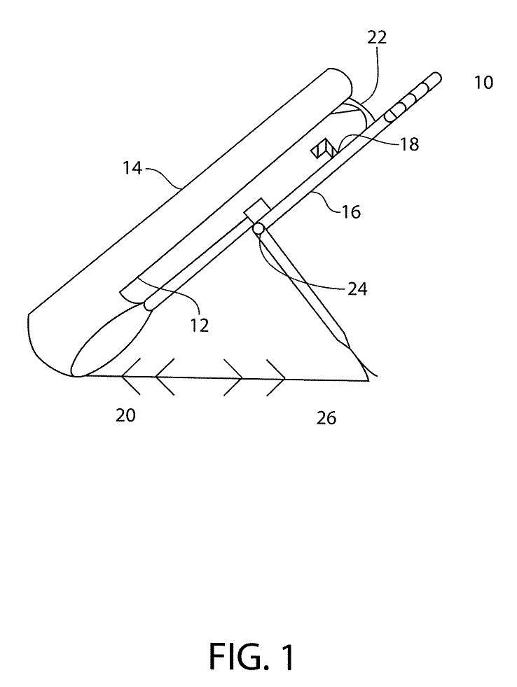

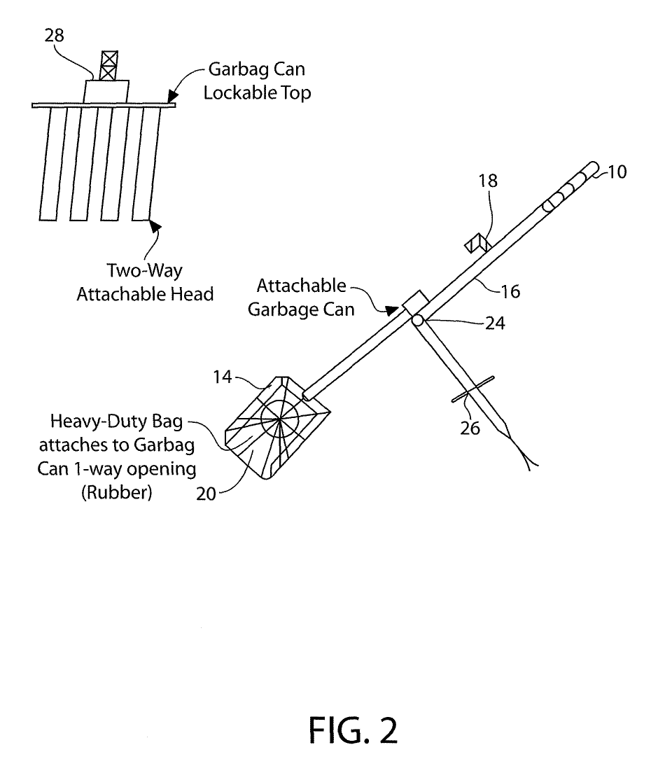

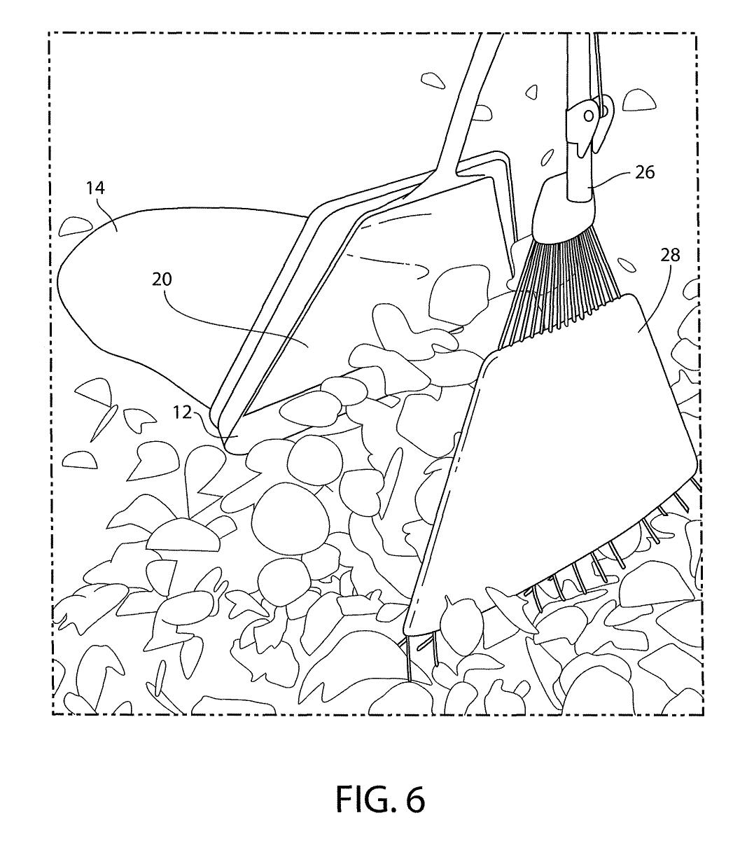

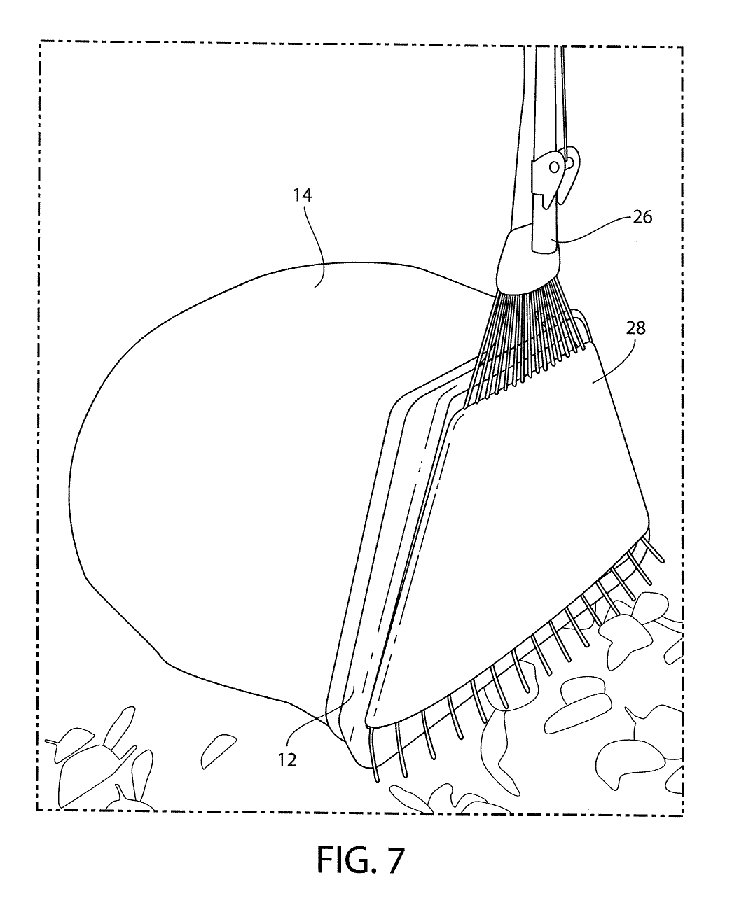

Reference is now made to FIGS. 1-7 which shows several views of several preferred embodiments of the invention. The tool may consist of a heavy-duty handle 10 with an attachment 12 designed to hold a garbage bag 14. The main shaft 16 includes a pivot handle 18 used to open and close the one-way open bag 20. The main shaft 16 may also include removable arms 22, which hold the bag 14 securely in place. The bag may either be emptied by pulling the pivot handle 18 or by unhooking the removable arms 22 and manually dumping, or replacing the bag 14. The bottom of the main shaft 16 may be a pivot joint 24 that moves the latch 26 attached to the bag 14 and locks it closed. The bottom of the main shaft 16 also provides an area to screw on attachable heads 28. The tool may come with a variety of heads. These attachments may include a grass rake, a garden rake, a broom, and a weed removal tool. Each head may have a threaded portion on the bottom to accommodate the threading on the main shaft. They can be quickly and easily screwed on. The main shaft 16 may be made of metal, wood, or other suitable material. Aluminum has been found to be particularly beneficial material for construction of main shaft 16 as well as other parts.

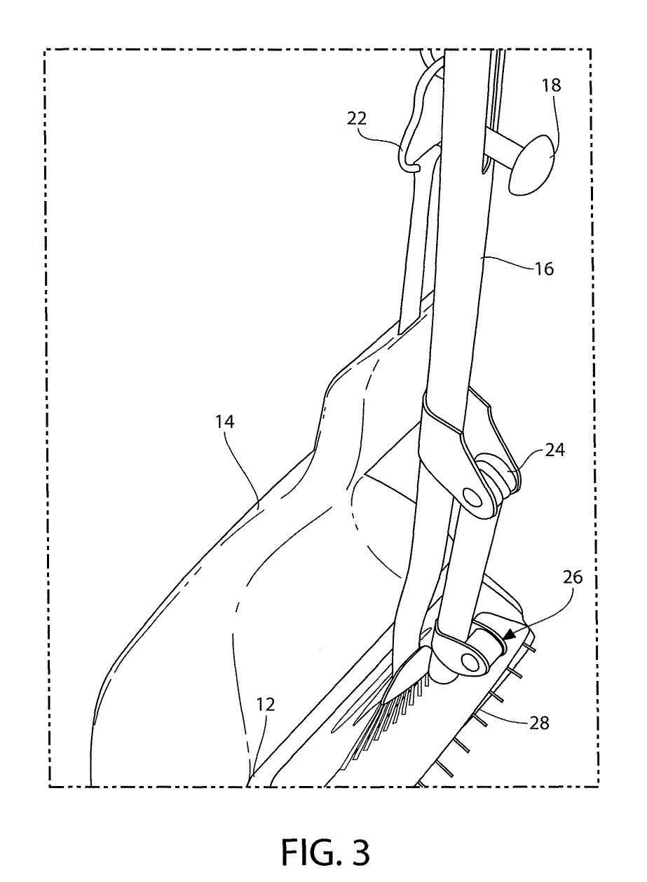

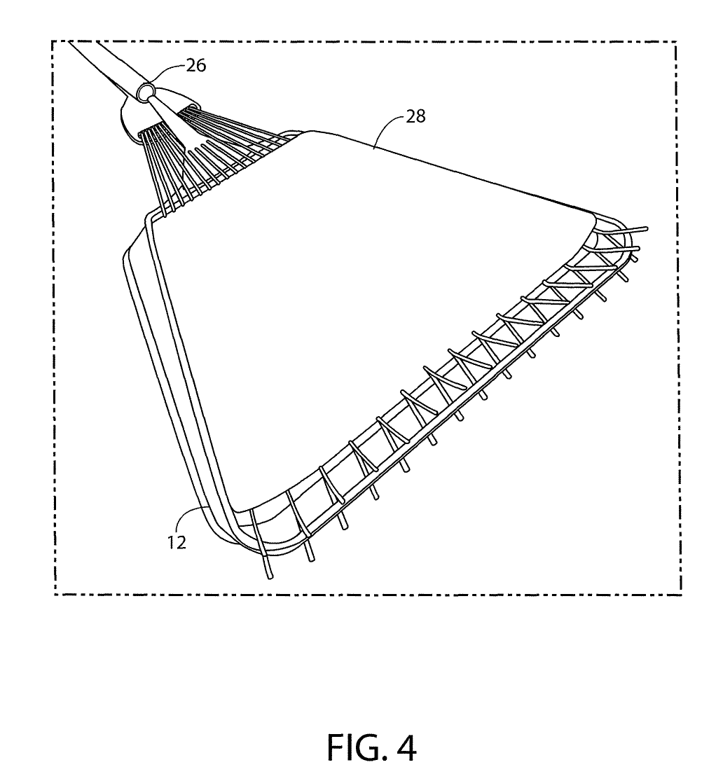

Reference is now made to FIGS. 3-7, which shows several views of a preferred embodiment of the present invention. FIG. 3 shows a detailed view of the features described above. FIG. 4 shows a detail view of rake attachment head 28 and garbage bag attachment 12, in this embodiment permanently attached. As can be seen in FIG. 4, the rake head attachment 28, in this embodiment permanently attached, has two set of tines. One set of tines point toward the garbage bag and the other set of tines point away from the bag. Rake head attachment 28 is preferably attached to a pulley system controlled by pivot handle 18 attached to the main shaft 16 (open and closes the garbage can). In the closed position the user can rake the yard of grass, leaves, and debris into multiple piles. Once completed the user can go to each pile, release the heavy-duty bag connected to the main shaft, and use the main latch (pushing down) to open the garbage can (two sided rake head), and rake the contents into the bag.

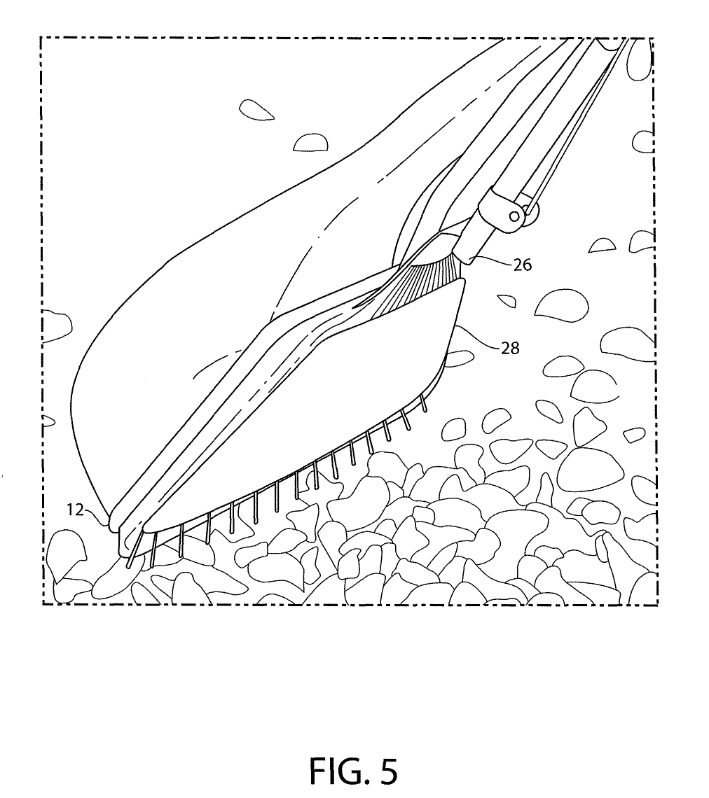

As shown in FIGS. 5-7, the device is intended to be used as a normal rake to form a pile then the pivot handle 18 is manipulated to actuate the latch 26. The pile of debris can then be deposited into the bag 14 for later disposal. Latch 26 when closed seals bag 14. Thus making it easy for a user to carry the rake with bag 14 filed with debris to a trash can or other location. Pivot handle 18 is then manipulated to open latch 26 and empty the contents of bag 14. Bag 14 is preferably a heavy duty lawn mower bag. Preferably a recyclable bag is used to line bag 14. More preferably a biodegradable bag is used to line bag 14.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

What is claimed:

1. A yard tool comprising:
an elongated handle,
an attachment capable of holding a bag in an open position,
an elongated member hingedly attached to said elongated handle,
a first plurality of tines fixably attached to said elongated member,
a bag,
a pivot handle in mechanical communication with said elongated member,
wherein said pivot handle controls an actuation of said elongated member.

2. The yard tool of claim 1, further comprising a second plurality of tines fixably attached to said elongated member, wherein said first plurality of tines are oriented antiparallel to said second plurality of tines.

3. The yard tool of claim 1, further comprising a second plurality of tines fixably attached to said elongated member, wherein said first plurality of tines extend toward said bag and said second plurality of tines extend away from said bag.

4. The yard tool of claim 1, further comprising removable arms attached to said elongated handle capable of holding said bag off of a surface.

5. The yard tool of claim 1, wherein said actuation of said elongated member comprises a swinging motion by means of a pivot attachment point between said elongated handle and said elongated member.

6. A yard tool comprising:
an elongated handle,
an attachment capable of holding a bag in an open position attached to said elongated handle,
an elongated member hingedly attached to said elongated handle,
a first plurality of tines fixably attached to said elongated member,
a second plurality of tines fixably attached to said elongated member,
a bag,
a pivot handle in mechanical communication with said elongated member,
wherein said pivot handle controls an actuation of said elongated member.

7. The yard tool of claim 6, wherein said first plurality of tines are oriented antiparallel to said second plurality of tines.

8. The yard tool of claim 6, wherein said first plurality of tines extend toward said bag and said second plurality of tines extend away from said bag.

9. The yard tool of claim 6, further comprising removable arms attached to said elongated handle capable of holding said bag off of a surface.

10. The yard tool of claim 6, wherein said actuation of said elongated member comprises a swinging motion by means of a pivot attachment point between said elongated handle and said elongated member.
